(19) United States
(12) Patent Application Publication
(10) Pub. No.: US 2005/0280752 A1
(43) Pub. Date: Dec. 22, 2005

(54) Optical film, backlight assembly and liquid crystal display device having the same

(76) Inventors: Dong-Hoon Kim, Seoul (KR); Jong-Dae Park, Seoul (KR); Jin-Sung Choi, Yongin-si (KR)

Correspondence Address: CANTOR COLBURN, LLP, 55 GRIFFIN ROAD SOUTH, BLOOMFIELD, CT, 06002, US

(21) Appl. No.: 11/157,292

(22) Filed: Jun. 21, 2005

(30) Foreign Application Priority Data
Jun. 22, 2004 (KR) 2004-46683
Aug. 13, 2004 (KR) 2004-64024

(51) Int. Cl. G02F 1/1335

(52) U.S. Cl. 349/62

(57) ABSTRACT

An optical film includes a base film and optical property enhancing members. The optical property enhancing members are disposed at the base film. Each of the optical property enhancing members has a boat bottom shape.

This application claims priority to Korean Patent Application No. 2004-46683 filed on Jun. 22, 2004, and Korean Patent Application No. 2004-64024 filed on Aug. 13, 2004, and all the benefits accruing therefrom under 35 U.S.C. §119, and the contents of which in their entirety are herein incorporated by reference.

### BACKGROUND OF THE INVENTION

1. Field of the Invention

The present invention relates to an optical film, a backlight assembly and a liquid crystal display device having the optical film. More particularly, the present invention relates to an optical film capable of enhancing optical properties, a backlight assembly and a liquid crystal display device having the optical film.

2. Description of the Related Art

Generally, a liquid crystal display device uses an optical film, especially a prism film, as a luminance enhancing film or a light reflection film. The optical film corresponds to a film having a base film including polyester and an ultraviolet (UV) curable resin that is laminated on the base film. The prism film condenses light to enhance a luminance perceived when viewing the liquid crystal display device from a front perspective.

FIG. 1 is a perspective view illustrating a backlight assembly having a conventional prism film. The backlight assembly in FIG. 1 is disclosed in U.S. Pat. No. 5,600,455.

Referring to FIG. 1, a light generated from a lamp 2 enters a light guide plate 3, a diffusion sheet 4, a first prism film 5a and a second prism film 5b in sequence. The first and second prism films 5a and 5b may also be called inverse prism films. Additionally, light that escapes the light guide plate 3 toward a direction opposite the diffusion sheet 4 is reflected toward the diffusion sheet 4 by a reflector 1. The first prism film 5a includes isosceles prisms extended in an x-direction that is substantially perpendicular to a longitudinal direction of the lamp 2. The second prism film 5b disposed over the first prism film 5a includes isosceles prisms extended in a y-direction that is substantially parallel with the longitudinal direction of the lamp 2. Each isosceles prism of the first and second prism films 5a and 5b makes contact with adjacent prisms. Therefore, lights of the x-direction or the y-direction are condensed toward a z-direction, which is substantially perpendicular to both the x-direction and the y-direction.

However, according to the conventional backlight assembly, two components, the first and second prism films 5a and 5b, are required to enhance luminance. Therefore, both a manufacturing cost and a weight of the backlight assembly are increased. When only one of the first and second prism films 5a and 5b is employed, the luminance is lowered.

### SUMMARY OF THE INVENTION

The present invention provides an improved optical film capable of enhancing luminance, even when only one optical film is employed. The present invention also provides a backlight assembly having the improved optical film. The present invention also provides a liquid crystal display device having the above backlight assembly.

In an exemplary optical film according to the present invention, the optical firm includes a base film and optical property enhancing members. The optical property enhancing members are formed on the base film. Each of the optical property enhancing members has a boat bottom shape having a streamlined cross-sectional shape when viewed from a top of each of the optical property enhancing members, and an arched cross-sectional shape when viewed from a side of each of the optical property enhancing members.

In another exemplary optical film according to the present invention, the optical film includes a base film and optical property enhancing members. The base film has a uniform thickness, and is disposed in an X-Y plane. The optical property enhancing members protrude from the base film toward a Z-direction that is substantially perpendicular to the X-Y plane. A cross section of the optical property enhancing members taken along an X-Z plane has an arched shape to condense an external light, and a cross section of the optical property enhancing members taken along a Y-Z plane has a saw tooth shape to condense the external light.

In still another exemplary optical film according to the present invention, the optical film includes a base film and a plurality of optical property enhancing members. The base film has a uniform thickness, and the base film is disposed in an X-Y plane. The optical property enhancing members protrude from the base film toward a Z-direction that is substantially perpendicular to the X-Y plane. A cross section of the optical property enhancing members taken along an X-Z plane has an arched shape to condense an external light, and a cross section of the optical property enhancing members taken along a Y-Z plane has an entasis saw tooth shape to condense the external light.

In still another exemplary optical film according to the present invention, the optical film includes a base film and prism patterns. The prism patterns are disposed at the base film, each of the prism patterns having an arch-shaped cross-sectional shape.

In an exemplary backlight assembly according to the present invention, the backlight assembly includes a lamp and an optical film. The lamp generates a light. The optical film has a base film and optical property enhancing members having a boat bottom shape and being disposed at the base film.

In an exemplary liquid crystal display device according to the present invention, the liquid crystal display device includes a light source, a liquid crystal display panel and a light adjusting member. The light source generates light. The liquid crystal display panel displays images using light generated by the light source. The light adjusting member includes a base film having first and second surfaces, and optical property enhancing members disposed at the first surface. The optical property enhancing members have a boat bottom shape. The light adjusting member receives the light generated by the light source to enhance optical properties of the light and provides the liquid crystal display panel with the light.

In another exemplary liquid crystal display device according to the present invention, the liquid crystal display device includes a liquid crystal display panel and a backlight assembly. The liquid crystal display panel displays images using light. The backlight assembly provides the liquid crystal display panel with the light. The backlight assembly includes a prism film having prism patterns discretely formed thereon. The prism patterns are protruded toward the liquid crystal display panel. Each of the prism patterns has an arch-shaped cross-sectional shape.

According to the present invention, the optical film includes a first face having prisms in which shapes are as described above and through which a light enters the optical film and a second face through which the light exits the optical film. Therefore, the light that enters the optical film is condensed and diffused to enhance luminance.

Furthermore, the optical film according to the present invention reduces a number of prism films to reduce weight and manufacturing cost of the liquid crystal display device.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a perspective view illustrating a backlight assembly having a conventional prism film;

FIG. 2 is a perspective view illustrating a backlight assembly according to an exemplary embodiment of the present invention;

FIG. 3 is a side view of a portion of the backlight assembly in FIG. 2 illustrating a method of guiding light using a light guide plate;

FIG. 4 is a partially cutout perspective view illustrating a light guide plate in FIG. 2;

FIG. 5 is a perspective view illustrating an inverse prism film according to an exemplary embodiment of the present invention;

FIG. 6 is a plan view illustrating a portion of an exemplary embodiment of an inverse prism film;

FIG. 7A is a cross-sectional view taken along line I-I′ in FIG. 6;

FIG. 7B is a cross-sectional view taken along line II-II′ in FIG. 6;

FIGS. 8A and 8B are cross-sectional views illustrating a light path of light passing through the inverse prism film of FIGS. 7A and 7B, respectively;

FIG. 9 is a perspective view illustrating an inverse prism film according to an exemplary embodiment of the present invention;

FIG. 10 is a plan view illustrating a portion of an exemplary embodiment of an inverse prism film;

FIG. 11A is a cross-sectional view taken along line III-III′ in FIG. 10;

FIG. 11B is a cross-sectional view taken along line IV-IV′ in FIG. 10;

FIGS. 12A and 12B are cross-sectional views illustrating a light path of light passing through the inverse prism film of FIGS. 11A and 11B, respectively;

FIG. 13A is a cross-sectional view illustrating an inverse prism film according to another exemplary embodiment of the present invention;

FIG. 13B is a cross-sectional view illustrating a light path of light passing through the inverse prism film in FIG. 13A;

FIG. 14A is a cross-sectional view illustrating an inverse prism film according to yet another exemplary embodiment of the present invention;

FIG. 14B is a cross-sectional view illustrating a light path of light passing through the inverse prism film in FIG. 14A;

FIG. 15 is a cross-sectional view illustrating an inverse prism film according to still another exemplary embodiment of the present invention;

FIG. 16 is an exploded perspective view illustrating a liquid crystal display device according to an exemplary embodiment of the present invention;

FIG. 17 is an exploded perspective view illustrating a liquid crystal display device according to another exemplary embodiment of the present invention;

FIG. 18 is an exploded perspective view illustrating a liquid crystal display device according to yet another exemplary embodiment of the present invention;

FIG. 19 is an exploded perspective view illustrating a liquid crystal display device according to still another exemplary embodiment of the present invention;

FIG. 20 is a perspective view illustrating the liquid crystal display device in FIG. 19;

FIG. 21 is a portion of a cross-sectional view taken along line V-V′ in FIG. 20;

FIG. 22 is a perspective view illustrating an inverse prism film according to an exemplary embodiment of the present invention;

FIG. 23 is a cross-sectional view taken along line VI-VI′ in FIG. 22;

FIG. 24A is a graph illustrating luminance distribution measured from a conventional inverse prism film; and

FIG. 24B is a graph illustrating luminance distribution measured from an inverse prism film of the present invention.

### DETAILED DESCRIPTION OF THE INVENTION

Hereinafter, exemplary embodiments of the present invention will be described in detail with reference to the accompanied drawings.

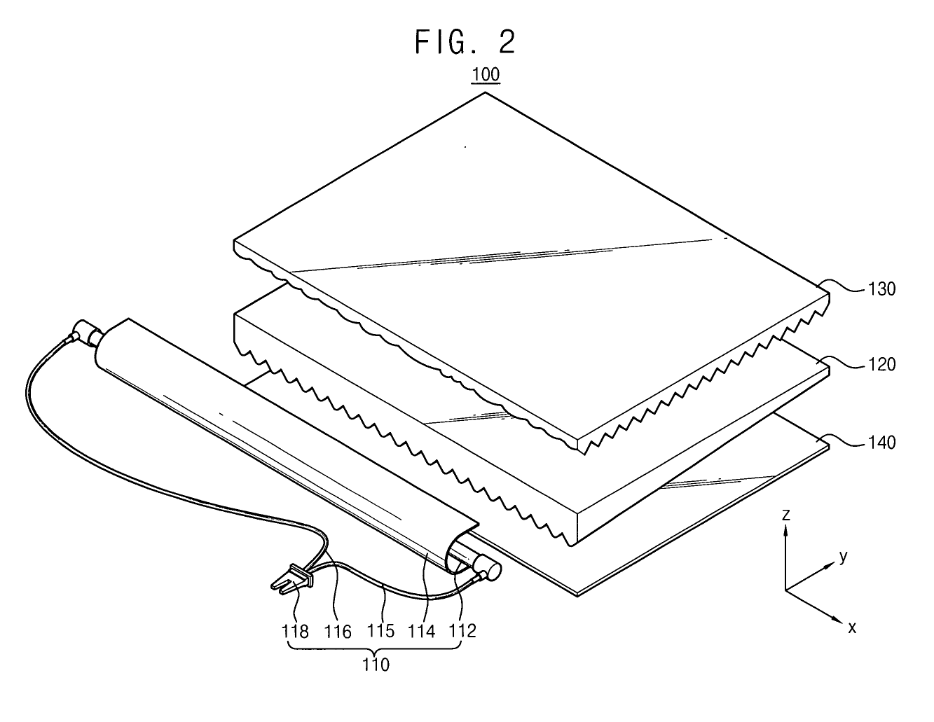

FIG. 2 is a perspective view illustrating a backlight assembly according to an exemplary embodiment of the present invention.

Referring to FIG. 2, a backlight assembly 100 according to an exemplary embodiment of the present invention includes a light generating section 110, a light guide plate 120, an inverse prism film 130 and a reflection sheet 140.

The light generating section 110 includes a lamp 112, a lamp cover 114, a first wire 115, a second wire 116, and a connector 118. A source voltage is applied to the lamp 112 through the connector 118 and the first and second wires 115 and 116. The lamp 112 generates light in response to the source voltage. The lamp cover 114 covers a portion of the lamp 112 and a portion of the reflection sheet 140 to reflect light generated by the lamp 112 toward the light guide plate 120.

The light guide plate 120 is disposed between the inverse prism film 130 and the reflection sheet 140. The light guide plate 120 has a plurality of prisms extended along a y-direction that is substantially perpendicular to a longitudinal direction of the lamp 112. Therefore, the light guide plate 120 guides light generated by the lamp 112 and light reflected by the reflection sheet 140 toward the inverse prism film 130.

An apex of the prisms of the light guide plate 120 may be rounded or pointed. In an exemplary embodiment, the apex of each of the prisms is rounded at a first end of the light guide plate 120 and gradually tapers to a point at a second end of the light guide plate 120. The first end of the light guide plate 120 is disposed proximate to the lamp 112. In other words, a curvature of the apexes decreases as a distance from the lamp 112 increases.

The inverse prism film 130 is disposed proximate to a light-exiting surface of the light guide plate 120 to condense or diffuse light guided from the light guide plate 120. Therefore, optical properties are controlled. The inverse prism film 130 has a plurality of prisms (or optical property enhancing members) facing the light-exiting surface of the light guide plate 120. The optical property enhancing members have a boat bottom shape. A longitudinal direction of the optical property enhancing members is substantially perpendicular to a longitudinal direction of the prisms of the light guide plate 120. The longitudinal direction of the optical property enhancing members is substantially parallel with a longitudinal direction of the lamp 112.

The reflection sheet 140 is disposed proximate to a bottom side of the light guide plate 120 that is opposite to the light-exiting surface of the light guide plate 120, which is disposed proximate to the inverse prism film 130. The reflection sheet 140 reflects leaked light from the light guide plate 120 toward the inverse prism film 130. The reflection sheet 140 may be flexible or rigid.

As described above, the light guide plate 120 includes prisms that are substantially perpendicular to a lamp 112, and apexes of the prisms may be roundly formed. Therefore, a bright line appearing on the light guide plate 120 is prevented.

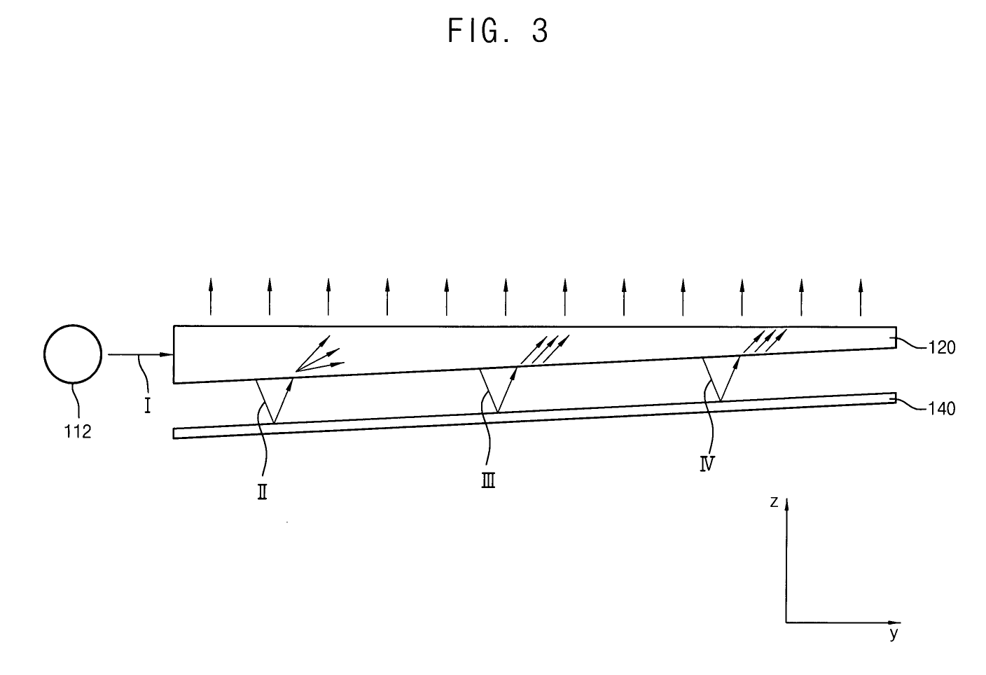

FIG. 3 is a side view of a portion of the backlight assembly in FIG. 2 illustrating a method of guiding light using a light guide plate.

Referring to FIGS. 2 and 3, a first light I generated by the lamp 112 enters the light guide plate 120 through a light incident face 121 of the light guide plate 120, and is guided to exit the light guide plate 120 through a light-exiting face 123.

A portion of the first light I is leaked from the light guide plate 120 to form a second light II. The second light II is reflected by the reflection sheet 140 to enter the bottom surface of the light guide plate 120 and exit the light guide plate 120 through the light-exiting face 123.

A portion of the second light II is leaked from the light guide plate 120 to form a third light Ill. The third light III is reflected from the reflection sheet 140 to enter the bottom surface of the light guide plate 120 and exit the light guide plate 120 through the light-exiting face 123. When entering the light guide plate 120, the second and third lights II and III are more diffused than the first light I due to a curvature of the prisms. In an exemplary embodiment, an amount of light diffusion increases as a distance from the lamp 112 increases. Thus, for example, a fourth light IV entering the bottom surface of the light guide plate 120 at a greater distance from the lamp 112 than the second and third lights II and III, is more diffused than the second and third lights II and III.

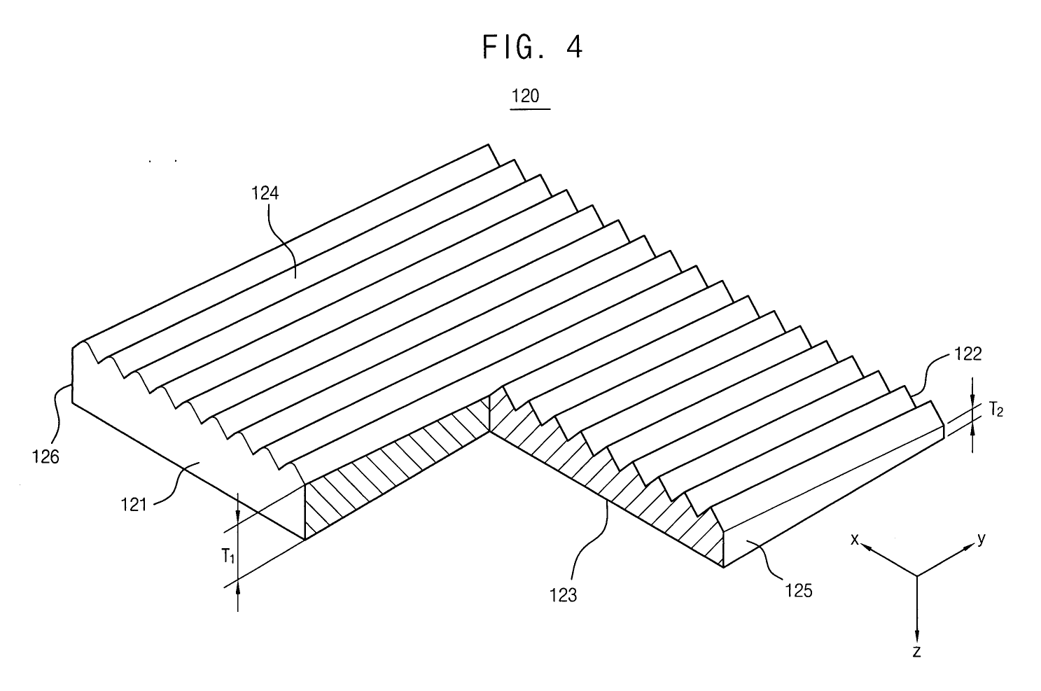

FIG. 4 is a partially cutout perspective view illustrating the light guide plate 120 in FIG. 2. The light guide plate 120 in FIG. 4 corresponds to a light guide plate employed by a wedge illumination type backlight assembly. In order to describe a shape of the light guide plate 120, a portion of the light guide plate 120 is removed.

Referring to FIGS. 2 and 4, the light guide plate 120 includes the light incident face 121 through which light generated by the lamp 112 enters the light guide plate 120, an opposite face 122 that is opposite to the light incident face 121, the light-exiting face 123 through which light exits the light guide plate 120, a bottom face 124 that is opposite to the light-exiting face 123, a first side face 125 and a second side face 126. Light generated by the lamp 112 enters the light guide plate 120 through the light incident face 121 and is guided to exit the light guide plate 120 through the light-exiting face 123.

The light incident face 121 is adjacent to the lamp 112. An upper edge of the light incident face 121 has a straight line shape and a lower edge of the light incident face 121 has a saw tooth shape. Each tooth of the saw tooth shaped edge has a shape of an isosceles triangle having a rounded apex. The light incident face 121 meets the bottom face 124 at a lower edge, and the light-exiting face 123 at an upper edge when viewed from a perspective of the reflection sheet 140. A valley between each adjacent tooth of the lower edge of the light incident face 121 is spaced apart from the upper edge of the light incident face 121 by a first distance T1.

The opposite face 122 is opposite to the light incident face 121. The opposite face 122 has an upper edge having a straight-line shape and a lower edge having a saw tooth shape. Each tooth of the lower edge of the opposite face 122 has a shape of an isosceles triangle. The opposite face 122 meets the bottom face 124 at the lower edge, and the light exiting face 123 at the upper edge. A valley between each adjacent tooth of the lower edge of the opposite face 122 is spaced apart from the upper edge of the opposite face 122 by a second distance T2. The light guide plate 120 corresponds to the wedge type backlight assembly. Therefore, the first distance T1 is larger than the second distance T2.

The light-exiting face 123 includes first to fourth edges. The first edge of the light-exiting face 123 meets the upper edge of the light incident face 121. The second edge of the light-exiting face 123 meets the upper edge of the opposite face 122. The third and fourth edges of the light-exiting faces 123 meet the first and second side faces 125 and 126, respectively. The inverse prism film 130 is disposed proximate to the light-exiting face 123, so that light that exits the light guide plate 120 through the light-exiting face 123 enters the inverse prism film 130.

The bottom face 124 is disposed opposite to the light-exiting face 123. A light reflected from the reflection sheet 140 enters the light guide plate 120 through the bottom face 124. The bottom face 124 includes prisms arranged substantially perpendicular to a longitudinal direction of the lamp 112. For example, a vertical angle of the prisms is in a range from about 100 degrees to about 120 degrees.

As described above, an apex of each of the prisms is rounded near the light incident face 121 but sharp near the opposite face 122. A rounded shape of the prisms may be formed through injection molding. Alternatively, a triangular prism may be formed first and then a portion of the triangular prism may be treated to achieve the rounded shape of the apex of a portion of each of the prisms.

The first side face 125 includes first to fourth edges and has a trapezoidal shape. The first side face 125 meets the light incident face 121 to form the first edge of the first side face 125. The first side face 125 meets the opposite face 122 to form the second edge of the first side face 125. The first side face 125 meets the light-exiting face 123 to form the third edge of the first side face 125. The first side face 125 meets the bottom face 124 to form the fourth edge of the first side face 125.

The second side face 126 includes first to fourth edges and has a trapezoidal shape. The second side face 126 meets the light incident face 121 to form the first edge of the second side face 126. The second side face 126 meets the opposite face 122 to form the second edge of the second side face 126. The second side face 126 meets the light-exiting face 123 to form the third edge of the second side face 126. The first side face 125 meets the bottom face 124 to form the fourth edge of the second side face 126.

In FIGS. 2 and 4, a distance between a ridge and a valley of each of the prisms of the light guide plate 120 is substantially equal, and vertical angles of each of the prisms are substantially equal. Alternatively, the distance between the ridge and the valley of the prisms of the light guide plate 120 may be different from each other, and vertical angles of each of the prisms may be different from each other. Furthermore, valleys defined by neighboring prisms are sharply formed, for example, in a V-shape, as shown in FIGS. 2 and 4. Alternatively, the valleys may be roundly formed.

In FIGS. 2 and 4, the prisms are extended substantially perpendicular to a longitudinal direction of the lamp 112. Alternatively, the prisms may be extended, for example, to form an angle of less than about 90 degree with respect to the longitudinal direction of the lamp 112. The valleys of the prisms are extended, for example, in a straight line that is substantially perpendicular to the longitudinal direction of the lamp 112. Alternatively, the valleys may be extended, for example, in a curved line.

The light guide plate 120 described above includes the prisms that condense light to enhance light efficiency. However, the backlight assembly 100 also includes the inverse prism film 130 that condenses and diffuses light and is disposed proximate to the light guide plate 120 to enhance visibility and display quality.

Hereinafter, exemplary embodiments of inverse prism films will be explained in detail referring to figures.

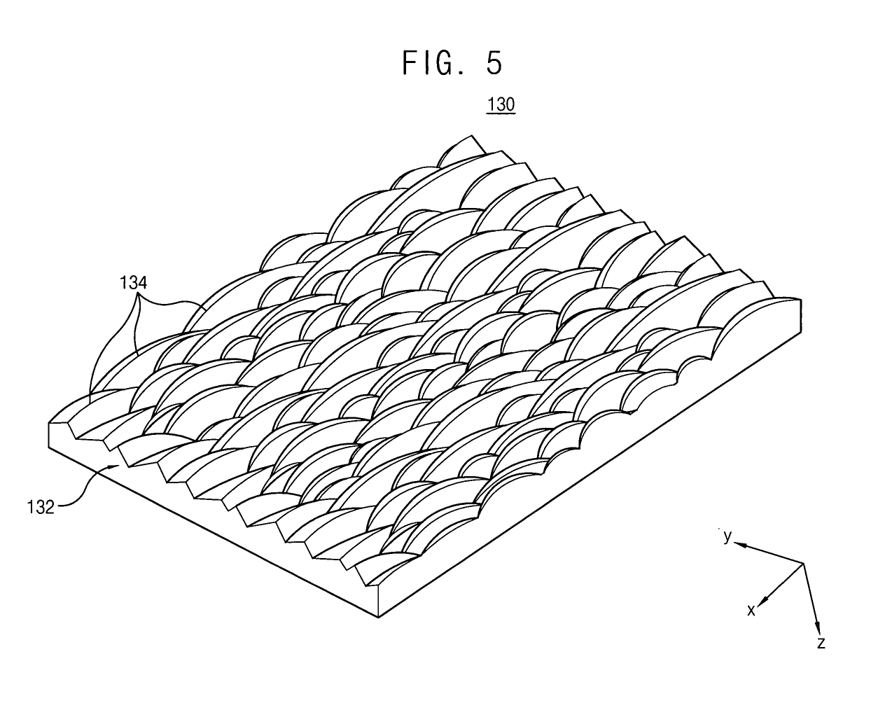

FIG. 5 is a perspective view illustrating an inverse prism film according to an exemplary embodiment of the present invention.

Referring to FIG. 5, the inverse prism film 130 according to an exemplary embodiment of the present invention includes a base film (or base) 132 and optical property enhancing members (or prisms) 134 formed on the base film 132. The optical property enhancing members 134 protrude from the base film 132 toward a same direction.

A surface having the optical property enhancing members 134 formed thereon faces the light-exiting face 123 of the light guide plate 120. The base film 132 and the optical property enhancing members 134 may include a same material. Alternatively, the base film 132 and the optical property enhancing members 134 may include different materials each having a different refractive index from each other.

The optical property enhancing members 134 protrude from the base film 132 to form a boat bottom shape. Each one of the optical property enhancing members 134 makes contact with adjacent optical property enhancing members 134 to form a substantially V-shaped trough. The optical property enhancing members 134 are arranged along an x-direction. In other words, a major axis of each of the optical property enhancing members 134 is substantially parallel to an x-direction that is substantially parallel to the longitudinal length of the lamp 112, and a minor axis of the optical property enhancing members 134 is substantially parallel to the y-direction that is substantially perpendicular to the x-direction.

The boat bottom shape has a streamline shape of which both ends are sharp and center portion is wide. The boat bottom shape is achieved by forming a substantially triangular prism shaped protrusion at a portion of the base film 132 in the x-direction such that the protrusion has a first end and a second end. A width and a height of the protrusion are minimal at both the first and second ends. The width and the height of the protrusion gradually increase while proceeding from the first and second ends toward a center portion of the protrusion. Thus the width and the height of the protrusion are substantially larger at the center portion than the width and height of the protrusion at the first and second ends.

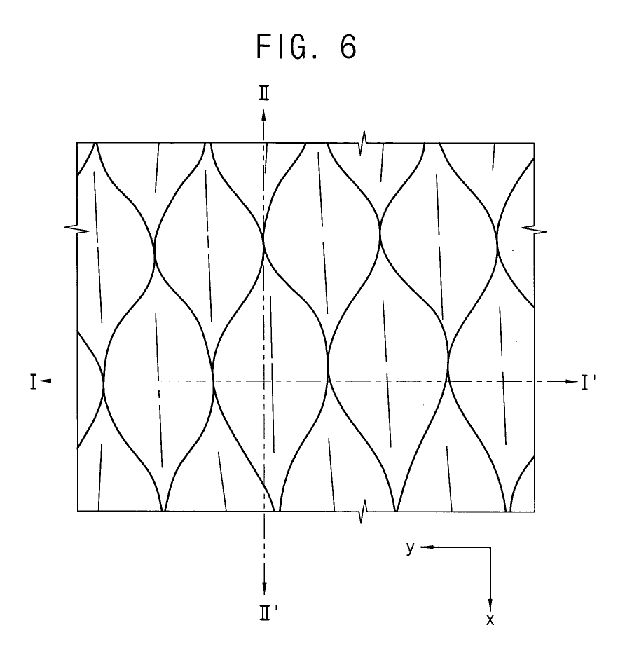

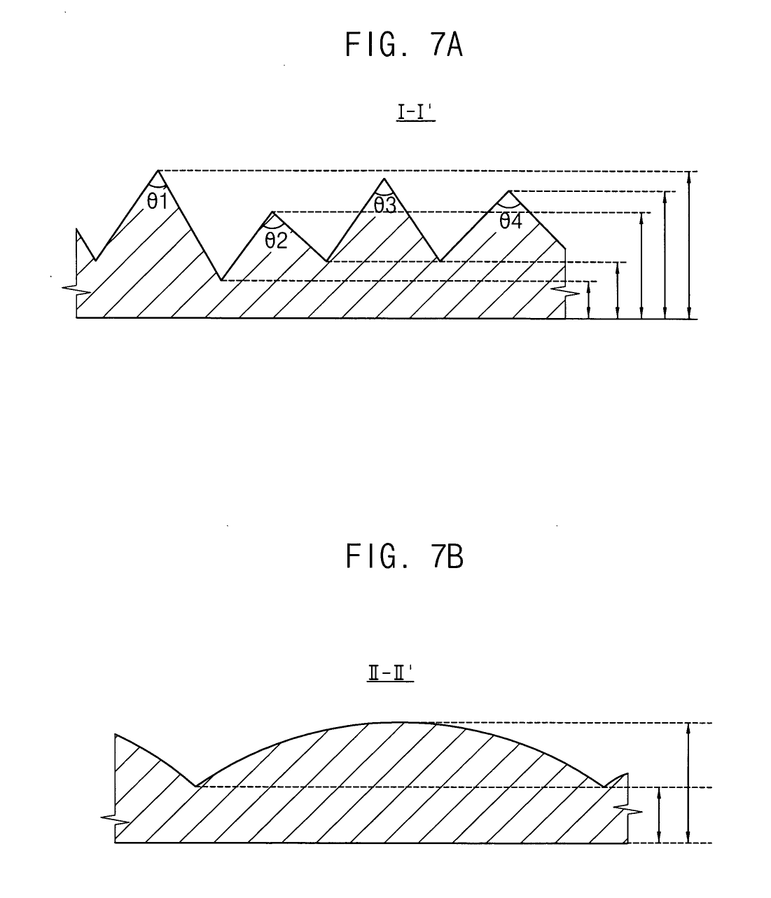

FIG. 6 is a plan view illustrating a portion of an exemplary embodiment of an inverse prism film. FIG. 7A is a cross-sectional view taken along line I-I′ in FIG. 6. FIG. 7B is a cross-sectional view taken along line II-II′ in FIG. 6.

Referring to FIGS. 6 to 7B, a cross section of the optical property enhancing members 134 along the y-direction has a plurality of saw tooth shapes. One tooth having a saw tooth shape makes contact with neighboring teeth having saw tooth shapes. Heights of each tooth may be different, and depths of the troughs formed between neighboring teeth may also be different from one another. A vertical angle of each of the teeth having the saw tooth shape ranges from about 60 degrees to about 90 degrees. For example, the vertical angle of the saw tooth shape is about 68 degrees. FIG. 7A shows, for example, first to fourth vertical angles θ1 to θ4, which may each be different from each other.

The optical property enhancing members 134 may be arranged on the base film 132 in a substantially random manner as shown in FIG. 5, or in a substantially regular pattern as shown in FIG. 6. In each of the exemplary embodiments of FIGS. 5 and 6, the height, width and vertical angle of each of the optical property enhancing members 134 are variable. Additionally, when referring to the height of the optical property enhancing members 134, it should be understood that the height is measured from the base film 132 to an apex of each of the optical property enhancing members 134. In other words, the height is a maximum height of a particular portion of the optical property enhancing members 134.

A cross section of the optical property enhancing members 134 along the x-direction has a round shape. Each round shaped optical property enhancing member may have a different curvature or height.

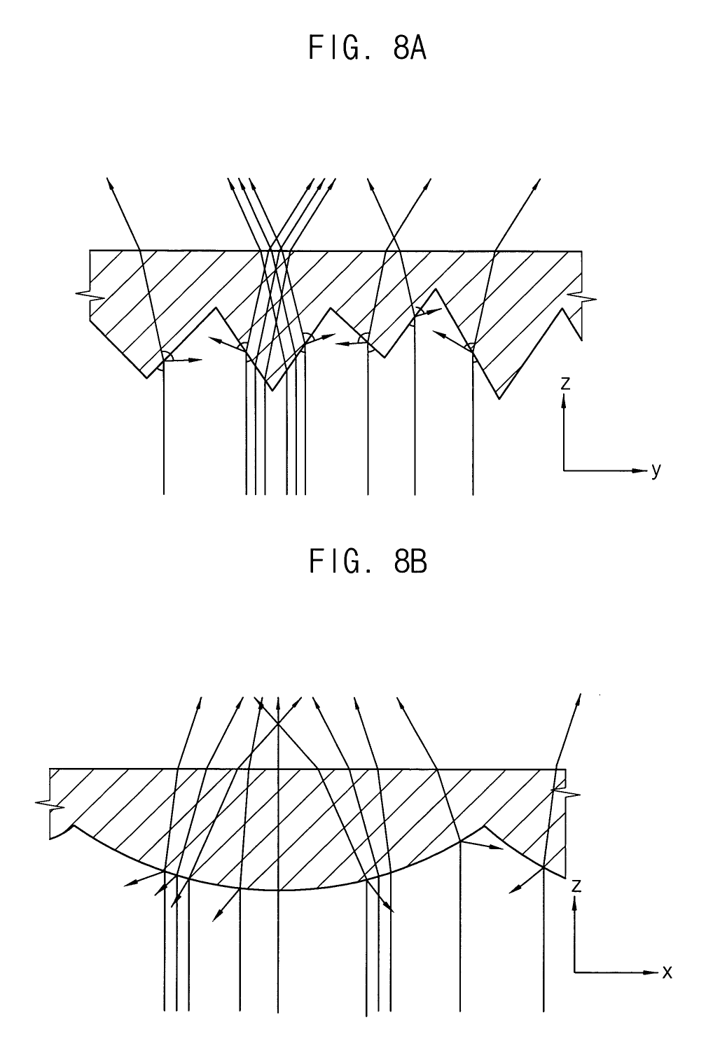

FIGS. 8A and 8B are cross-sectional views illustrating a light path of light passing through the inverse prism film 130 of FIGS. 7A and 7B, respectively. In other words, FIG. 8A corresponds to FIG. 7A, and FIG. 8B corresponds to FIG. 7B.

Referring to FIG. 8A, light that enters the inverse prism film 130 through a sloped side of a particular optical property enhancing member 134 is shifted toward an oppositely sloped side of the particular optical property enhancing member 134 according to Snell's law. Therefore, each of the optical property enhancing members 134 condenses light that enters the inverse prism film 130 through opposite sides of each of the optical property enhancing members 134. Two neighboring optical property enhancing members 134 diffuse light that enters adjacent sloped faces of the two neighboring optical property enhancing members 134.

Referring to FIG. 8B, light that enters the inverse prism film 130 through oppositely sloped sides of a curved portion of one of the optical property enhancing members 134 is shifted toward a center of the optical property enhancing members 134 according to Snell's law.

Therefore, a particular optical property enhancing member 134 having a curved shape, when viewed in cross section along the x-direction, condenses light that enters opposite sides of the particular optical property enhancing member 134. Adjacent sides of two neighboring optical property enhancing members 134 diffuse light that enters the adjacent sides.

As described above, the inverse prism film according to an exemplary embodiment of the present invention includes the boat bottom shaped optical property enhancing members 134 having the saw tooth shape when viewed in cross section along the y-direction and the round shape when viewed in cross section along the x-direction that is substantially perpendicular to the y-direction. The inverse prism film 130 prevents deterioration of a display quality, even if one of the optical property enhancing members 134 is defective.

Furthermore, the optical property enhancing members 134 have the boat bottom shape having a curved surface. Therefore, bright lines and total reflection caused by flat surfaces are reduced.

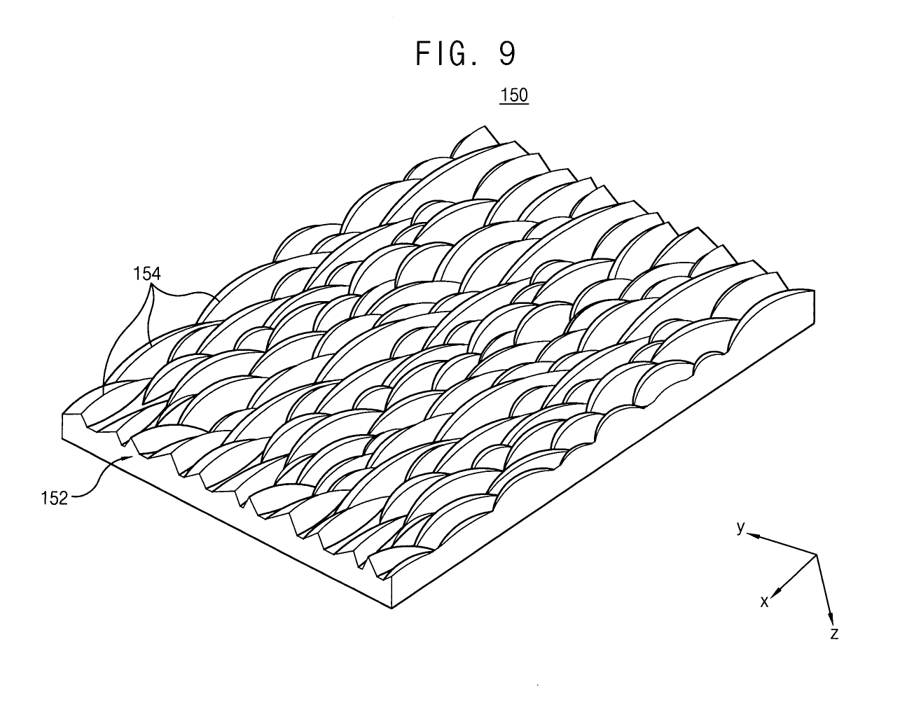

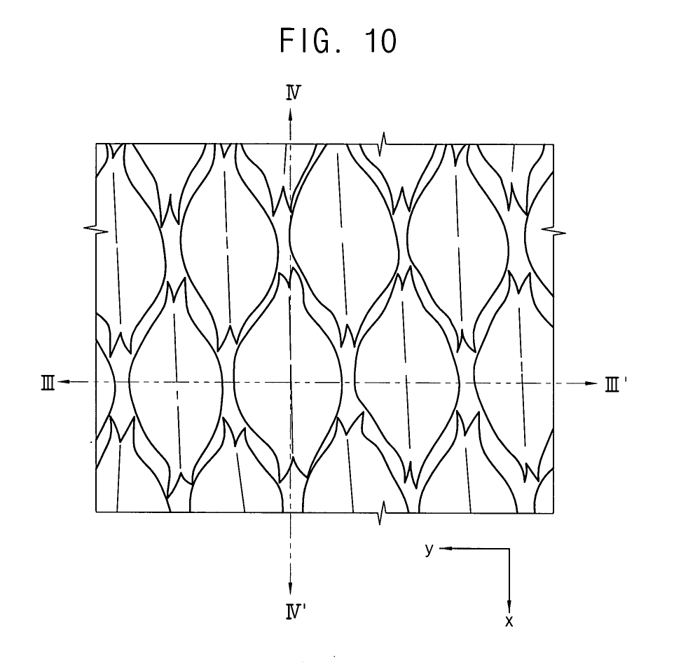

FIG. 9 is a perspective view illustrating an inverse prism film according to an exemplary embodiment of the present invention, and FIG. 10 is a plan view illustrating a portion of the inverse prism film in FIG. 9.

Referring to FIG. 9, an inverse prism film 150 according to an exemplary embodiment of the present invention includes a base film (or base) 152 and optical property enhancing members (or prisms) 154 formed on the base film 152. The optical property enhancing members 154 protrude from the base film 152 toward a same direction. The optical property enhancing members 154 are formed on the base film 152, such that the base film 152 is exposed between the optical property enhancing members 154. In other words, the optical property enhancing members 154 are spaced apart from each other by flat-bottomed troughs.

A surface having the optical property enhancing members 154 formed thereon faces the light-exiting face 123 of the light guide plate 120. The base film 152 and the optical property enhancing members 154 include, for example, a same material.

The optical property enhancing members 154 have the boat bottom shape. The optical property enhancing members 154 having the boat bottom shape are spaced apart from each other. The optical property enhancing members 154 are arranged along the x-direction. In other words, a major axis of the optical property enhancing members 154 is substantially parallel to the x-direction and a minor axis of the optical property enhancing members 154 is substantially parallel to a y-direction that is substantially perpendicular to the x-direction. The boat bottom shape has a streamline shape in which both ends are sharp and a center portion is wide. A structure of the boat bottom shape is substantially same as that described above referring to FIG. 5.

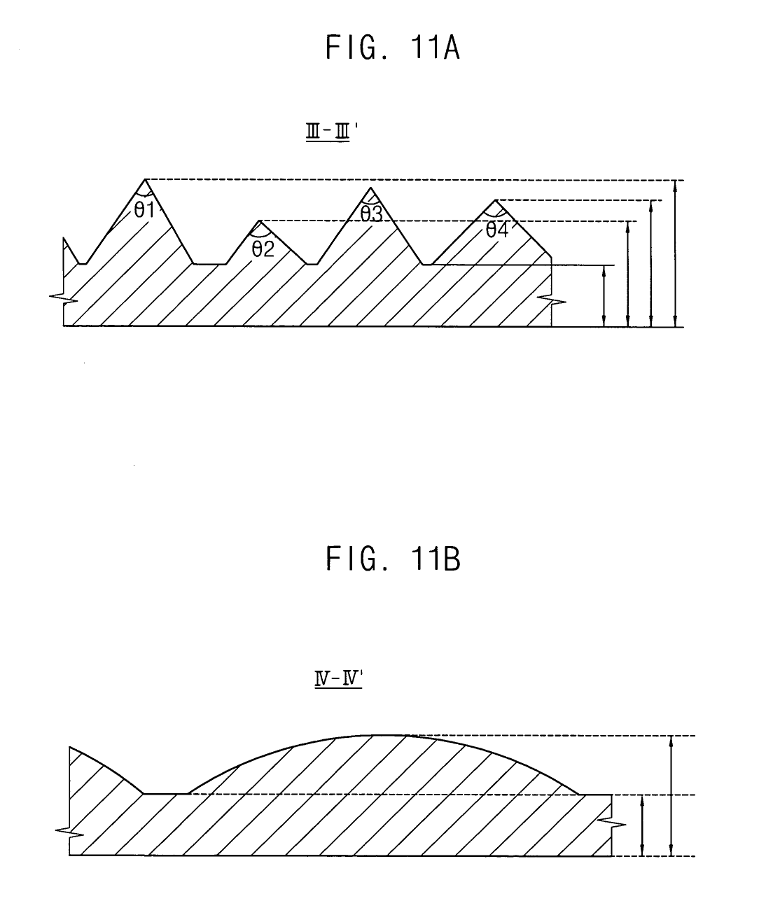

FIG. 10 is a plan view illustrating a portion of an exemplary embodiment of an inverse prism film. FIG. 11A is a cross-sectional view taken along line III-III′ in FIG. 10. FIG. 11B is a cross-sectional view taken along line IV-IV′ in FIG. 10.

Referring to FIGS. 10 to 11B, a cross section of the optical property enhancing members 154 along the y-direction has a plurality of saw tooth shapes. One tooth having a saw tooth shape is spaced apart from neighboring teeth having saw tooth shapes. Heights of each tooth may be different from one another, but depths of the flat-bottomed troughs formed between neighboring teeth may be substantially equal. A vertical angle of each of the teeth having the saw tooth shape ranges from about 60 degrees to about 90 degrees. For example, the vertical angle of the saw tooth shape is about 68 degrees. FIG. 11A shows, for example, the first to fourth vertical angles θ1 to θ4, which may each be different from each other.

The optical property enhancing members 154 may be arranged on the base film 152 in a substantially random manner as shown in FIG. 9, or in a substantially regular pattern as shown in FIG. 10. In each of the exemplary embodiments of FIGS. 9 and 10, the height, the width and the vertical angle of each of the optical property enhancing members 154 are variable.

A cross section of the optical property enhancing members 154 along the x-direction has a round shape. Each round shaped optical property enhancing member may have a different curvature or height.

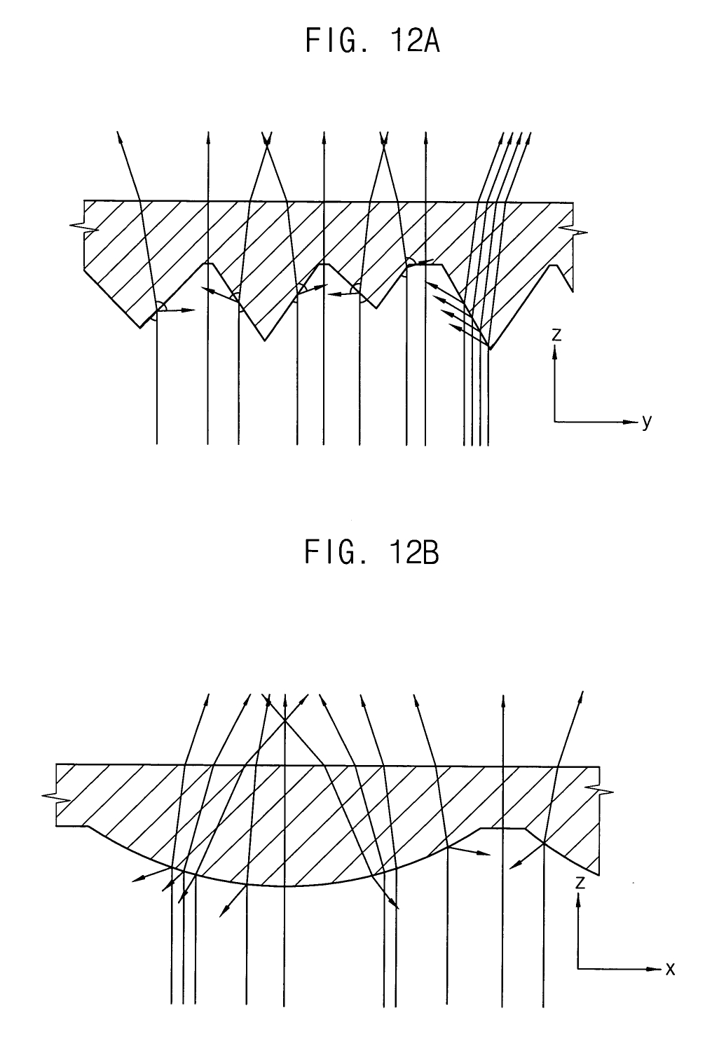

FIGS. 12A and 12B are cross-sectional views illustrating a light path of a light passing through the inverse prism film 150 of FIGS. 11A and 11B, respectively. In other words, FIG. 12A corresponds to FIG. 11A, and FIG. 12B corresponds to FIG.

Referring to FIG. 12A, light that enters the inverse prism film 150 through a sloped side of a particular optical property enhancing member 154 is shifted toward an oppositely sloped side of the particular optical property enhancing member 154 according to Snell's law. Therefore, each of the optical property enhancing members 154 condenses light that enters the inverse prism film 150 through opposite sides of each of the optical property enhancing members 154. Two neighboring optical property enhancing members 154 diffuse light that enters adjacent sloped faces of the two neighboring optical property enhancing members 154. Light that enters the inverse prism film vertically through the flat-bottomed trough between adjacent optical property enhancing members 154 exits the inverse prism film 150 vertically.

Referring to FIG. 12B, light that enters the inverse prism film 150 through oppositely sloped sides of a curved portion of the optical property enhancing members 154 is shifted toward a center of the optical property enhancing members 154 according to Snell's law.

Therefore, a particular optical property enhancing member 154 having a curved shape, when viewed in cross section along the x-direction, condenses light that enters opposite sides of the particular optical property enhancing member 154. Adjacent sides of two neighboring optical property enhancing members 154 diffuse light that enters the adjacent sides. Light that enters the inverse prism film 150 vertically through the flat-bottomed troughs between the optical property enhancing members 154 exits the inverse prism film 150 vertically.

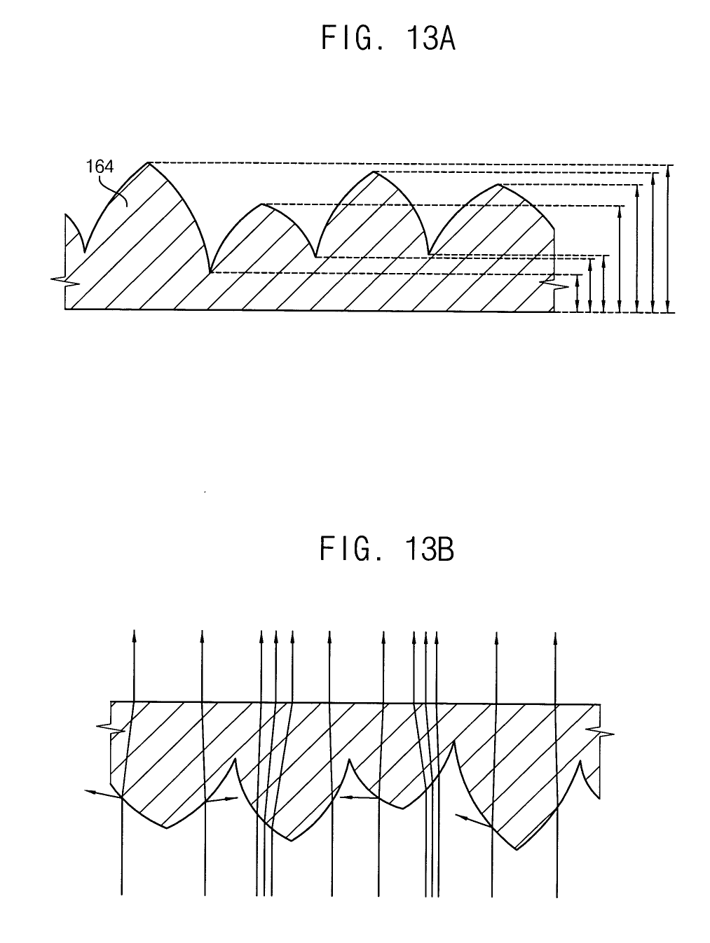

FIG. 13A is a cross-sectional view illustrating an inverse prism film according to another exemplary embodiment of the present invention, and FIG. 13B is a cross-sectional view illustrating a light path of light passing through the inverse prism film in FIG. 13A.

Referring to FIGS. 13A and 13B, a cross-sectional shape of each optical property enhancing member 164 has a saw tooth shape in which sides of each tooth are outwardly rounded. Hereinafter, the saw tooth shape in which sides of each tooth are outwardly rounded is referred to as “entasis saw tooth shape”.

As shown in FIG. 13A, when viewed in cross section along a transverse direction of the optical property enhancing members 164, the optical property enhancing members 164 have the entasis saw tooth shape. The transverse direction is substantially perpendicular to a longitudinal direction of the optical property enhancing members 164. The optical property enhancing members 164 having the entasis saw tooth shape condense and diffuse light provided by the light guide plate 120. Troughs formed between neighboring entasis saw tooth shapes have different depths from each other, and the entasis saw tooth shapes have varying heights.

A cross-section of the optical property enhancing members 164, which is taken along a longitudinal direction of the optical property enhancing members 164 also the round shape as shown in FIGS. 7B and 11B. Curvatures of each of the optical property enhancing members 164 may be different or identical.

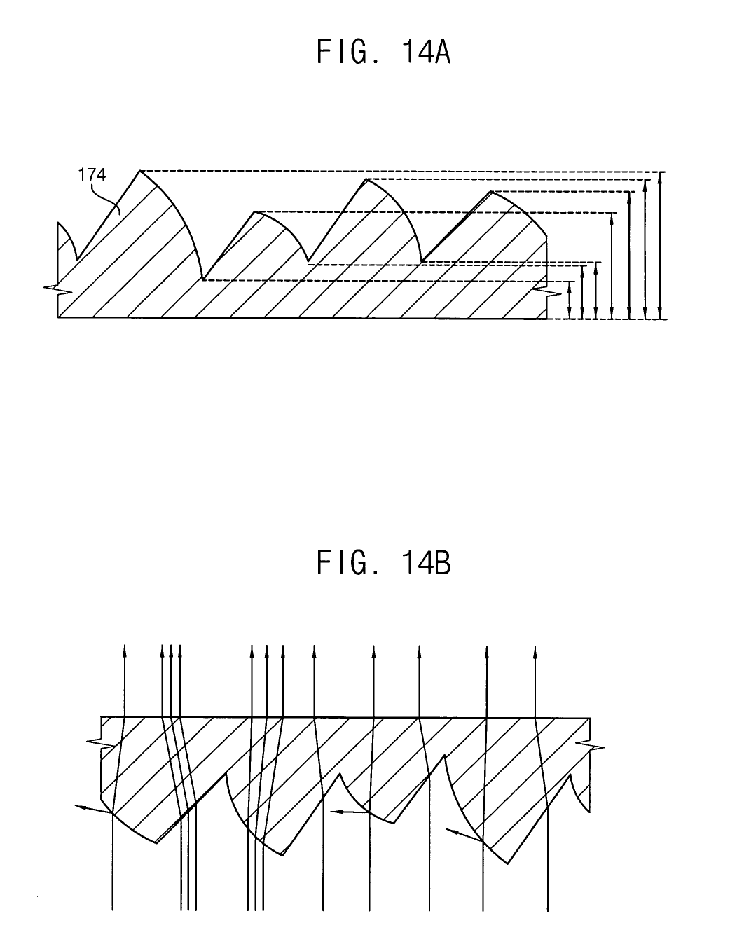

FIG. 14A is a cross-sectional view illustrating an inverse prism film according to yet another exemplary embodiment of the present invention, and FIG. 14B is a cross-sectional view illustrating a light path of light passing through the inverse prism film in FIG. 14A.

Referring to FIGS. 14A and 14B, a cross-sectional shape of each optical property enhancing member 174 has a saw tooth shape in which a first edge is straight and a second edge is outwardly rounded. Hereinafter, the saw tooth shape in which the first edge is straight and the second edge is outwardly rounded is referred to as “semi-entasis saw tooth shape”.

As shown in FIG. 14A, when viewed in cross section along a transverse direction of the optical property enhancing members 174, the optical property enhancing members 174 have the semi-entasis saw tooth shape. The optical property enhancing members having the semi-entasis saw tooth shape condense and diffuse light provided by the light guide plate 120. Troughs formed between neighboring semi-entasis saw tooth shapes have different depths from each other, and the semi-entasis saw tooth shapes have varying heights.

A cross-section of the optical property enhancing member 174, which is taken along a longitudinal direction of the optical property enhancing member 174 also has the round shape as shown in FIGS. 7B and 11B. Curvatures of the optical property enhancing members 174 may be different or identical.

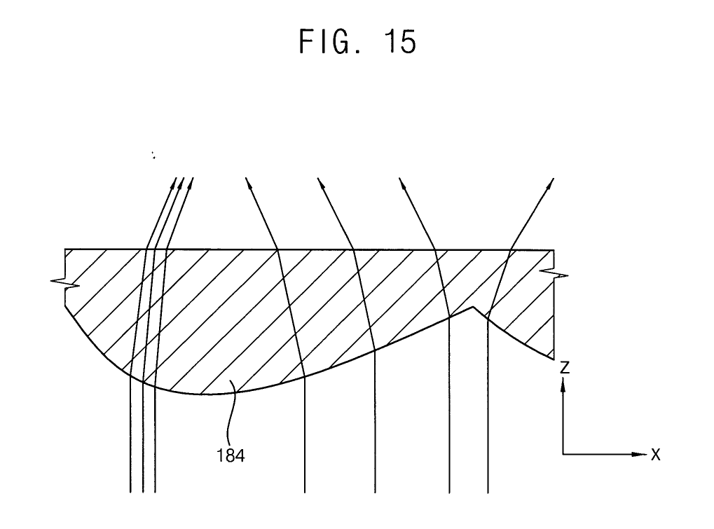

FIG. 15 is a cross-sectional view illustrating an inverse prism film according to yet another exemplary embodiment of the present invention. FIG. 15 illustrates a cross section of an optical property enhancing member (or prism) 184, which is taken along a longitudinal direction of the optical property enhancing member 184.

Referring to FIG. 15, a cross section of the optical property enhancing member 184 is asymmetric. In other words, a curvature of a first side is larger than a curvature of a second side.

Light that enters the optical property enhancing member 184 through the first side having a large curvature is more refracted than a light that enters the optical property enhancing member through the second side having a small curvature.

As described above, an amount of refraction may be adjusted by controlling an amount of curvature of the optical property enhancing member 184.

Although not shown in FIG. 15, two adjacent optical property enhancing members 184 diffuse light that enters through adjacent sides of the two adjacent optical property enhancing members 184.

Hereinafter, a liquid crystal display device having an inverse prism film according to an exemplary embodiment of the present invention will be explained.

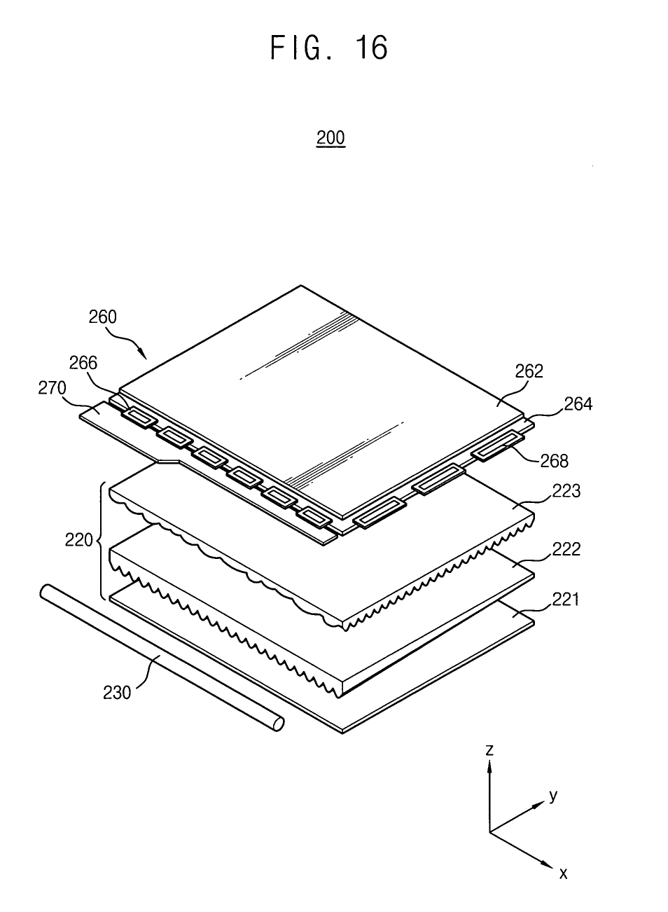

FIG. 16 is an exploded perspective view illustrating a liquid crystal display device according to an exemplary embodiment of the present invention.

Referring to FIG. 16, a liquid crystal display device 200 according to an exemplary embodiment of the present invention includes a lamp 230, a light adjusting section 220 and a liquid crystal display panel 260. The light adjusting section 220 is disposed proximate to the lamp 230 to direct light generated by the lamp 230 to the liquid crystal display panel 260. The light adjusting section 220 includes a reflection sheet 221, a light guide plate 222, and an inverse prism film 223. A light generated by the lamp 230 enters the inverse prism film 223 via the light guide plate 222 and the reflection sheet 221 to be condensed and diffused. The liquid crystal display panel 260 displays images using the condensed and diffused light.

The liquid crystal display panel 260 includes a color filter substrate 262, a thin film transistor (TFT) substrate 264, a source printed circuit board (PCB) 270, a source driver 266 and a gate driver 268.

Various light sources such as, for example, a cold cathode fluorescent lamp (CCFL), a light emitting diode (LED), an external electrode fluorescent lamp (EEFL), etc. may be employed as the lamp 230.

The light guide plate 222 includes a prism pattern formed thereon, so that a light generated from the lamp 230 is guided upward by the prism pattern and exits the light guide plate 222. Light that exits the light guide plate 222 enters the liquid crystal display panel 260 via the inverse prism film 223. The inverse prism film 223 may be substantially similar to one of the exemplary embodiments shown in FIGS. 5-15.

The inverse prism film 223 is disposed proximate to the light guide plate 222, such that optical property enhancing members on a surface of the inverse prism film 223 face the light guide plate 222 and a longitudinal direction of the optical property enhancing members of the inverse prism film 223 are substantially perpendicular to a longitudinal direction of the prisms of the light guide plate 222.

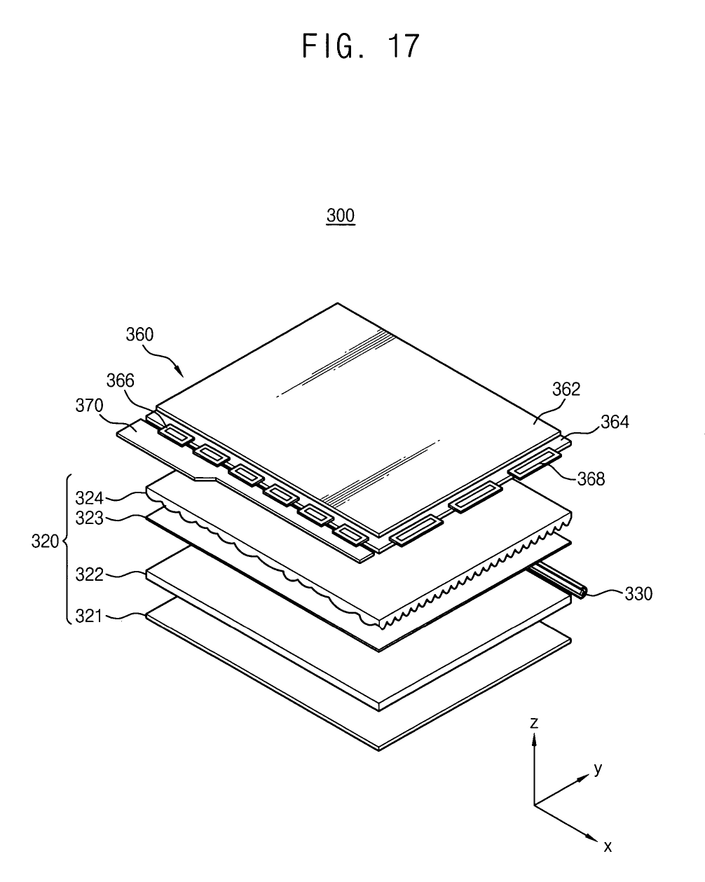

FIG. 17 is an exploded perspective view illustrating a liquid crystal display device according to another embodiment of the present invention.

Referring to FIG. 17, a liquid crystal display device 300 according to this exemplary embodiment of the present invention includes a light adjusting section 320 that adjusts a light generated from a lamp 330, and a liquid crystal display panel 360 that displays images using light adjusted by the light adjusting section 320.

The liquid crystal display panel 360 includes a color filter substrate 362, a TFT substrate 364, a source PCB 370, a source driver 366 and a gate driver 368.

Various light sources such as, for example, a cold cathode fluorescent lamp (CCFL), a light emitting diode (LED), an external electrode fluorescent lamp (EEFL), etc. may be employed as the lamp 330.

The light adjusting section 320 receives light generated from the lamp 330 and provides the liquid crystal display panel 360 with the light. The light adjusting section 320 includes a reflection sheet 321, a light guide plate 322, a diffusion film 323 and an inverse prism film 324.

Light generated from the lamp 330, which is disposed at a side of the light guide plate 322, enters the light guide plate 322 to be provided to the diffusion film 323. The light is diffused by the diffusion film 323. The light that passes through the diffusion film 323 is then provided to the inverse prism film 324. The light that passes through the inverse prism film 424 is then provided to the liquid crystal display panel 360.

The inverse prism film 324 includes optical property enhancing members that condense light to enhance luminance. The inverse prism film 324 may be substantially similar to one of the exemplary embodiments shown in FIGS. 5-15.

The inverse prism film 324 is disposed proximate to the light guide plate 322, such that the optical property enhancing members face the light guide plate 322 and a longitudinal direction of the optical property enhancing members of the inverse prism film 324 is substantially perpendicular to a longitudinal direction of prisms disposed on a surface of the light guide plate 322.

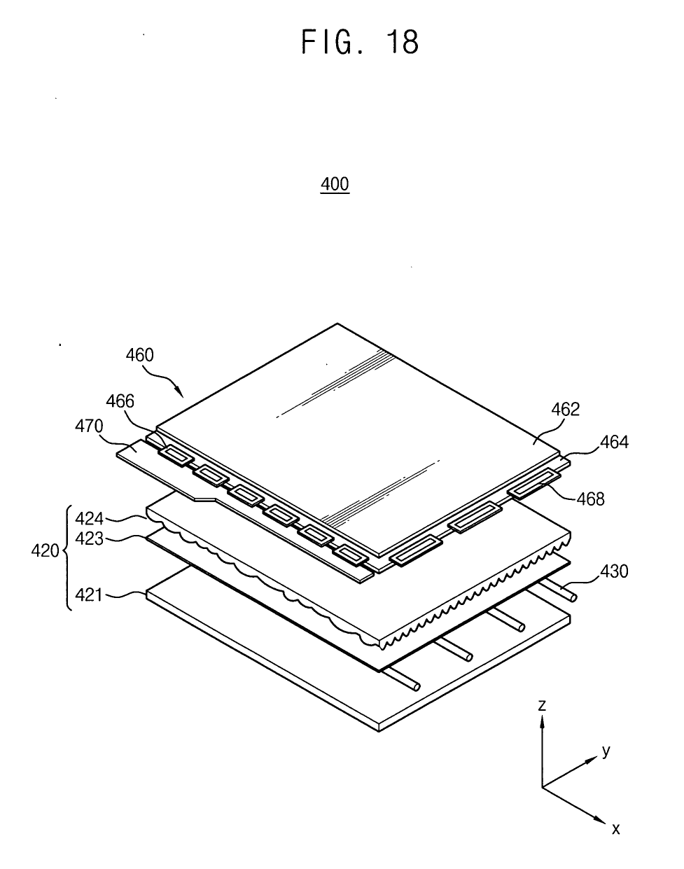

FIG. 18 is an exploded perspective view illustrating a liquid crystal display device according to yet another exemplary embodiment of the present invention.

Referring to FIG. 18, a liquid crystal display device 400 according to this exemplary embodiment of the present invention includes a light adjusting section 420 that adjusts light generated by lamps 430, and a liquid crystal display panel 460 that displays images using light adjusted by the light adjusting section 420.

The liquid crystal display panel 460 includes a color filter substrate 462, a TFT substrate 464, a source PCB 470, a source driver 466 and a gate driver 468.

Various light sources such as, for example, a cold cathode fluorescent lamp (CCFL), a light emitting diode (LED), an external electrode fluorescent lamp (EEFL), etc. may be employed as the lamps 430.

The light adjusting section 420 receives light generated from the lamps 430 and provides the liquid crystal display panel 460 with the light. The light adjusting section 420 includes a reflection sheet 421, a diffusion film 423 and an inverse prism film 424.

The lamps 430 are disposed substantially parallel to each other such that each of the lamps is proximate to a portion of the reflection sheet 421 on one side of the lamps 430 and proximate to the diffusion film 423 on an opposite side of the lamps 430. Light generated by the lamps 430 enters the diffusion film 423 directly or light generated from the lamps 430 is reflected by the reflection sheet 421 and enters the diffusion film 423. The light is diffused by the diffusion film 423. The light that passes through the diffusion film 423 is provided to the inverse prism film 424. The light that passes through the inverse prism film 424 is provided to the liquid crystal display panel 460.

The inverse prism film 424 includes optical property enhancing members that condense light to enhance luminance. The inverse prism film 424 may be substantially similar to one of the exemplary embodiments shown in FIGS. 5-15.

The inverse prism film 424 is disposed proximate to the diffusion film 423, such that the optical property enhancing members face the diffusion film 423 and a longitudinal direction of the optical property enhancing members of the inverse prism film 324 is substantially parallel to a longitudinal direction of the lamps 430.

A region directly above the lamps 430 is brighter than a region deviated from the lamps 430. Therefore, in order to make a luminance uniform, an angle and a curvature of optical property enhancing members may be adjusted. For example, optical property enhancing members may be formed such that optical property enhancing members disposed over the lamps have a larger tilt angle than the optical property enhancing members deviated from the lamps.

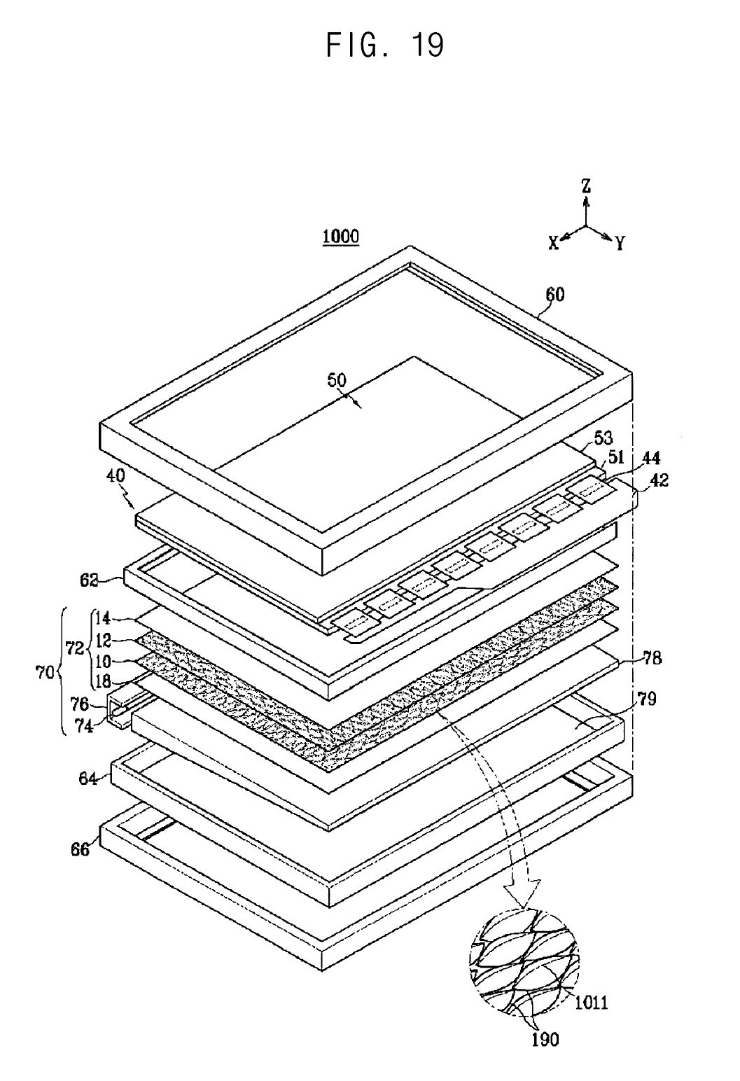

FIG. 19 is an exploded perspective view illustrating a liquid crystal display device according to still another exemplary embodiment of the present invention.

Referring to FIG. 19, a liquid crystal display device 1000 according to the present exemplary embodiment includes a liquid crystal display panel assembly 40 that displays images using light and a backlight assembly 70 that provides the liquid crystal display panel assembly 40 with light. The liquid crystal display device 1000 further includes a top chassis 60, an upper mold fame 62, a bottom chassis 64 and a lower mold frame 66 for fastening the liquid crystal display panel assembly 40 to the backlight assembly 70.

The backlight assembly 70 provides the liquid crystal display panel assembly 40 with light, and guides the light toward the liquid crystal panel assembly 40. The backlight assembly 70 may enhance front-view luminance and a luminance-uniformity of the liquid crystal display device 1000.

The liquid crystal display panel assembly 40 includes a liquid crystal display panel 50, a tape carrier package (TCP) 44 and a PCB 42. The liquid crystal display panel 50 includes a TFT substrate 51 including a plurality of TFTs, a color filter substrate 53 disposed proximate to a first side of the TFT substrate 51 and a liquid crystal layer (not shown) disposed between the TFT substrate 51 and the color filter substrate 53. A polarizer (not shown) that polarizes light generated by the backlight assembly 70 is disposed proximate to a second side of the TFT substrate 51, and an analyzer (not shown) that analyzes the light is disposed proximate to the color filter substrate 53.

The TFT substrate 51 includes a first transparent substrate and the plurality of TFTs arranged in a matrix shape and electrically connected to gate lines and data lines. Each of the TFTs includes a gate electrode that is electrically connected to a gate line, a source electrode that is electrically connected to a data line, and a drain electrode that is electrically connected to a pixel electrode. The pixel electrode includes an optically transparent and electrically conductive material such as indium tin oxide (ITO), indium zinc oxide (IZO), etc.

In response to the PCB 42 applying electric signals to the data line and the gate line, a TFT is turned on to apply a pixel voltage to the pixel electrode.

The color filter substrate 53 faces the TFT substrate 51. The color filter substrate 53 includes red-color filters, green-color filters and blue-color filters. The color filter substrate 53 further includes a common electrode. The common electrode includes an optically transparent and electrically conductive material such as ITO, IZO, etc. In response to the pixel voltage being applied to the pixel electrode of the TFT substrate 51, electric fields are generated between the pixel electrode and the common electrode to alter an arrangement of liquid crystal molecules of the liquid crystal layer, so that optical transmissivity of the liquid crystal layer is changed to display images.

In order to control timing of applying driving signals, the PCB 42 is electrically connected to the liquid crystal display panel assembly 40 through the TCP 44. The PCB 42 receives an image signal and applies a data signal and a gate signal to data lines and gate lines, respectively, of the liquid crystal display panel 50 through the TCP 44.

The backlight assembly 70 is disposed proximate to the liquid crystal display panel assembly 40 to provide the liquid crystal display panel assembly 40 with light. The backlight assembly 70 is fastened to the bottom chassis 64. The backlight assembly 70 includes a lamp 74, a lamp cover 76, a light guide plate 78, a light-reflecting sheet 79 and optical sheets 72. The lamp 74 generates light. The light guide plate 78 guides light generated by the lamp 74 toward the liquid crystal display assembly 40. The light-reflecting sheet 79 is disposed proximate to a first side of the light guide plate 78 to reflect light toward the liquid crystal display panel assembly 40. The optical sheets 72 are disposed proximate to a second side the light guide plate 78 to enhance optical properties of light that exits the light guide plate 78. The optical sheets 72 will be explained later in detail.

An inverter board (not shown) that corresponds to a PCB for applying power to the lamp 74 is disposed on a backside of the bottom chassis 64. The inverter board transforms an external power into a power that is appropriate to the lamp 74, and provides the power to the lamp 74.

A signal processing PCB (not shown) is electrically connected to the PCB 42 to convert an analog data signal into a digital signal that is applied to the liquid crystal display panel 50.

The top chassis 60 is disposed over the liquid crystal display panel assembly 40. The top chassis 60 fastens the liquid crystal display panel assembly 40 to the lower mold frame 66. The PCB 42 is bent and disposed under the TFT substrate 51. The lower mold frame 66 receives the backlight assembly 70. The liquid crystal display device 1000 may further include a front case and a back case.

The optical sheets 72 include a protection sheet 14, a first inverse prism film 10, a second inverse prism film 12 and a light-diffusing sheet 18. The light-diffusing sheet 18 diffuses light that exits the light guide plate 78, and then the first and second inverse prism films 10 and 12 condense the light. The first and second inverse prism films 10 and 12 are disposed such that a longitudinal direction of first prism patterns 190 of the first inverse prism film 10 is substantially perpendicular to a longitudinal direction of second prism patterns of the second inverse prism film 12. The protection sheet 14 is disposed proximate to the second inverse prism film 12 to protect the second prism patterns of the second inverse prism film 12.

The optical sheets according to the present invention are not limited to the optical sheets 72 in FIG. 19. For example, the optical sheets 72 include the first and second inverse prism films 10 and 12. Alternatively, the optical sheets 72 may include only one inverse prism film.

The first prism patterns 190 are arranged along an x-direction that corresponds to a longitudinal direction of the liquid crystal display device 1000. A height of each of the first prism patterns 190 decreases from a center of each of the first prism patterns 190 toward edge portions of each of the first prism patterns. When viewed from the top of each of the first prism patterns 190, a width of each of the first prism patterns 190 decreases from the center of each of the first prism patterns 190 toward the edge portions of each of the first prism patterns 190. The second prism patterns of the second inverse prism film 12 have substantially same shape as the first prism patterns 190 of the first inverse prism film 10, but the second prism patterns have a different longitudinal direction from that of the first prism patterns 190. In other words, the longitudinal direction of the first prism patterns 190 is substantially perpendicular to the longitudinal direction of the second prism patterns.

A method of manufacturing the first and second inverse prism films 10 and 12 having the first prism patterns 190 and second prism patterns, respectively, will not be explained, because a person skilled in the art may easily discern such a method by referring to FIG. 19.

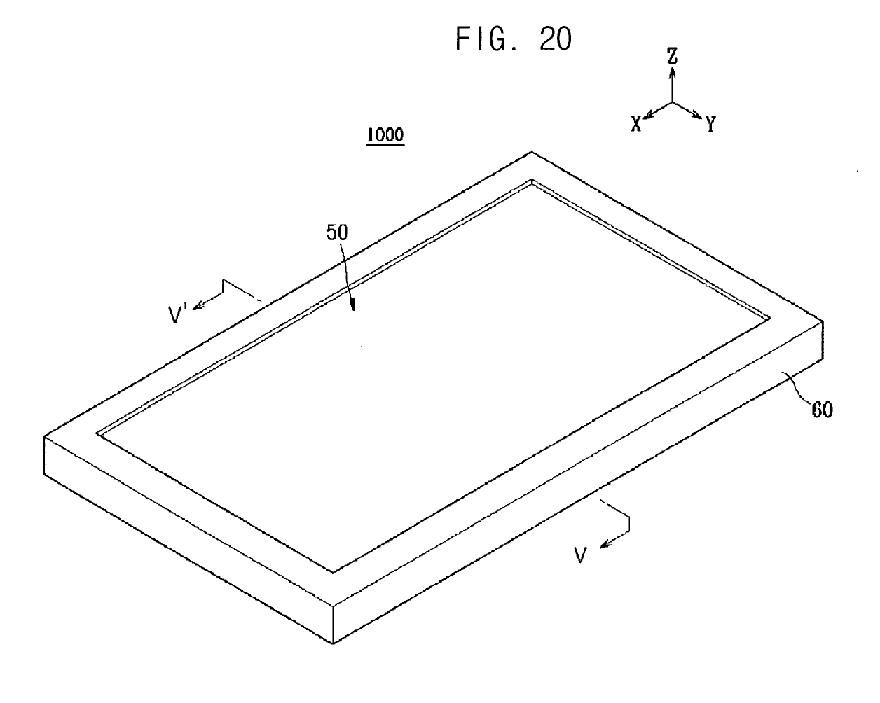

FIG. 20 is a perspective view illustrating the liquid crystal display device in FIG. 19.

Light generated from the backlight assembly 70 condensed by the first and second inverse prism films 10 and 12 and advanced along a z-direction, so that clear images may be displayed. Hereinafter, a process of altering an advancing direction of light will be explained.

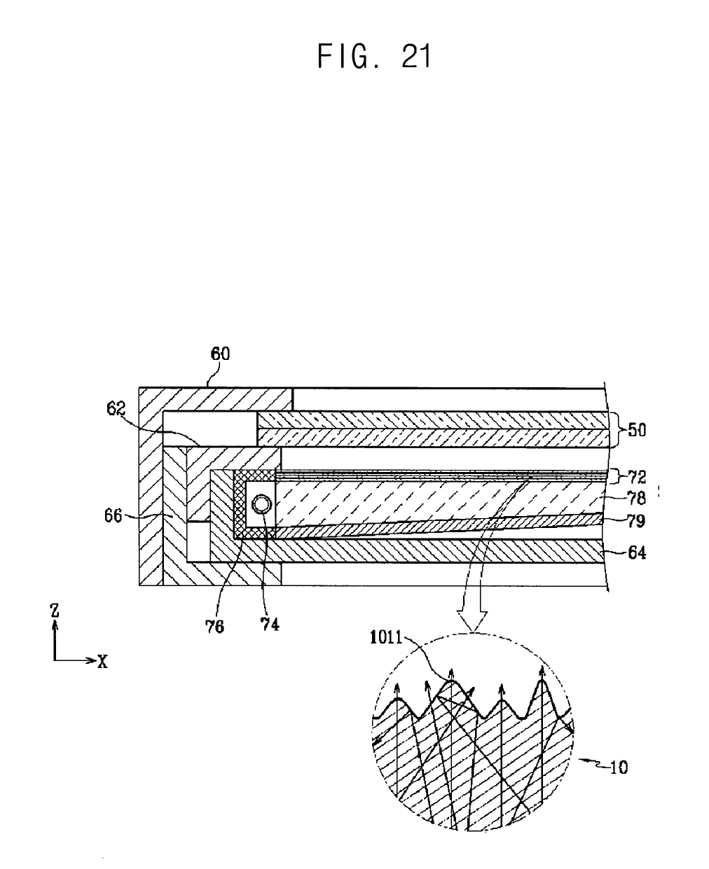

FIG. 21 is a cross-sectional view taken along line V-V′ in FIG. 20.

Referring to a blown up portion of FIG. 19 and to FIG. 21, each of the first prism patterns 190 is upwardly protruded from a base surface of the first inverse prism film 10. In other words, the first prism patterns 190 are protruded toward the liquid crystal display panel 50. Each of the first prism patterns 190 has rounded top portion 1011 to minimize light loss. Light advancing toward the rounded top portion 1011 exits, but light advancing toward a side portion of the first prism patterns 190 may be totally reflected, so that an amount of light advancing toward the rounded top portion 1011 increases. Each of the first prism patterns 190 may have a different height. The second prism patterns may have identical shape with the first prism patterns 190. Therefore, any repetitive explanation will be omitted.

Hereinafter, a shape of the first prism patterns 190 and the second prism patterns will be explained in detail.

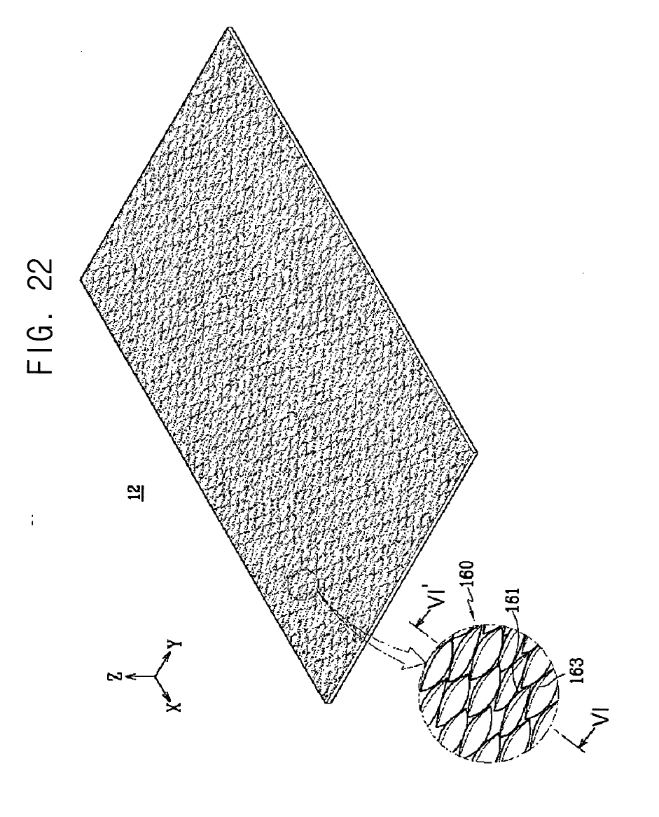

FIG. 22 is a perspective view illustrating an inverse prism film according to an exemplary embodiment of the present invention.

Referring to FIG. 22, the second inverse prism film 12 has the second prism patterns 160 that are substantially identical with the first prism patterns 190 of the first inverse prism film 10. However, the longitudinal direction of the second prism patterns 160 is substantially perpendicular to the longitudinal direction of the first prism patterns.

The second prism patterns 160 may each have a different size from each other. For example, a first adjacent prism pattern 161 and a second adjacent prism pattern 163 adjacent to each other have different sizes from each other. Hereinafter, the first and second adjacent prism patterns will be described.

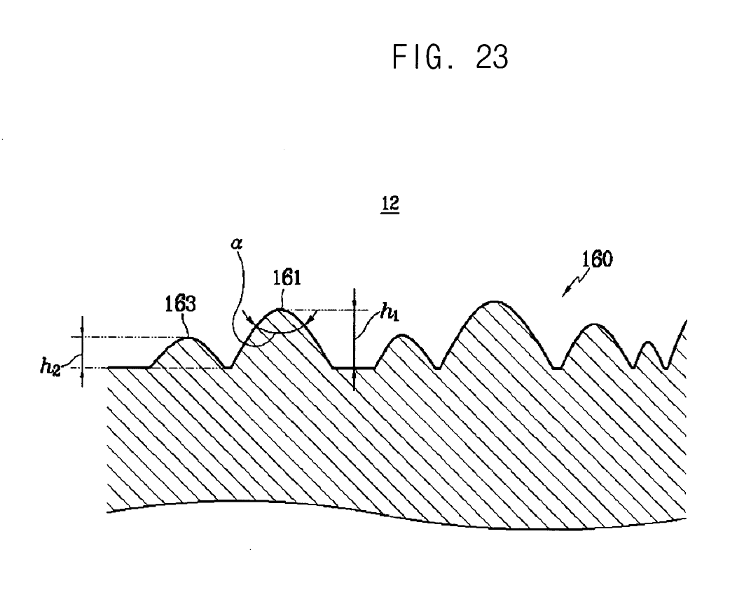

FIG. 23 is a cross-sectional view taken along line VI-VI′ in FIG. 22. Although FIG. 23 shows the second inverse prism film 12, it should be noted that the first inverse prism film 10 is substantially identical.

Referring to FIG. 23, the first and second adjacent prism patterns 161 and 163 have different sizes from each other. Each of the first and second adjacent prism patterns 161 and 163 is protruded toward the liquid crystal display panel 50. Each of the first and second adjacent prism patterns 161 and 163 has a rounded top portion. A vertical angle α defined by a tangent surface of each of the first and second adjacent prism patterns 161 and 163 is about 90 degrees.

The first and second adjacent prism patterns 161 and 163 have different heights from each other. The first adjacent prism pattern 161 has a first height h1, and the second adjacent prism pattern 163 has a second height h2. A height ratio of the first height h1 to the second height h2 is in a range from about 2.5:1 to about 4.0:1. When the height ratio of the first height h1 to the second height h2 is less than about 2.5, a property of an inverse prism film is deteriorated. On the contrary, when the height ratio of the first height h1 to the second height h2 is greater than about 4.0, a surface the inverse prism film becomes too rough to condense light.

A height difference between the first and second heights h1 and h2 is in a range from about 10 μm to about 25 μm. When the height difference is less than 10 μm, a property of the inverse prism film is deteriorated. On the contrary, when the height difference is greater than about 25 μm, the surface the inverse prism film becomes too rough to condense light.

When the height difference and the height ratio described above are within the ranges stated above, light exits the second inverse prism film 12 through the first adjacent prism pattern 161 by a first amount that is in a range from about 85% to about 95%, and through the second adjacent prism pattern 163 by a second amount that is in a range from about 5% to about 15%. In other words, an amount of about 85% to about 95% of light exits the prism film through a taller prism pattern, and an amount of about 15% to about 5% of light exits the prism film through a shorter prism pattern.

Hereinafter, an experimental example will be explained. The present invention is not limited by the experimental example described below.

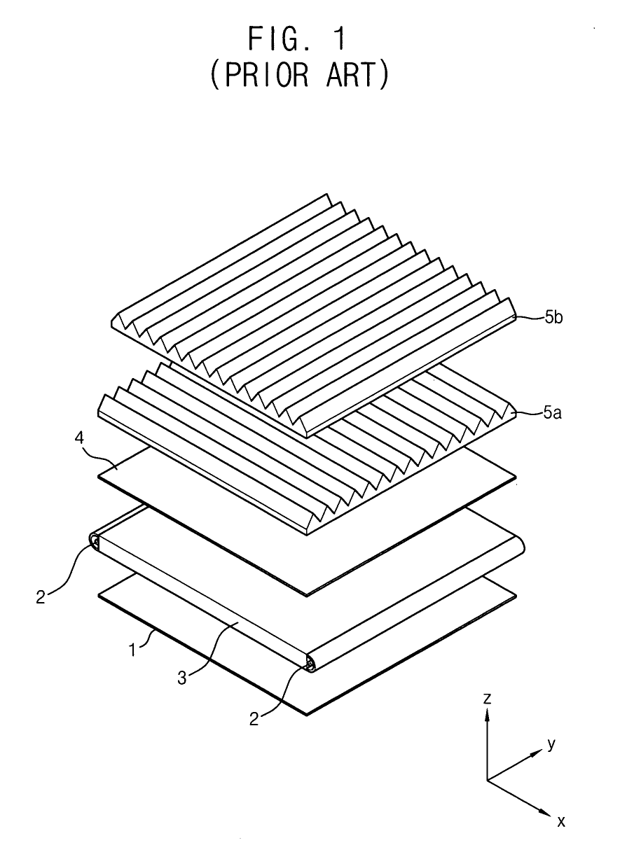

The first and second inverse prism films 10 and 12 described above were employed for the experimental example, and an inverse prism film of FIG. 1 was employed for a comparative example. The inverse prism film employed for the comparative example has a pitch of about 50 μm and a vertical angle α of about 90 degrees. The pitch corresponds to a distance between two prisms adjacent to each other.

In the experimental example, the first and second inverse prism films 10 and 12 are employed. A simulation method is well known to a person skilled in the art, so that a detailed explanation about the simulation method will be omitted.

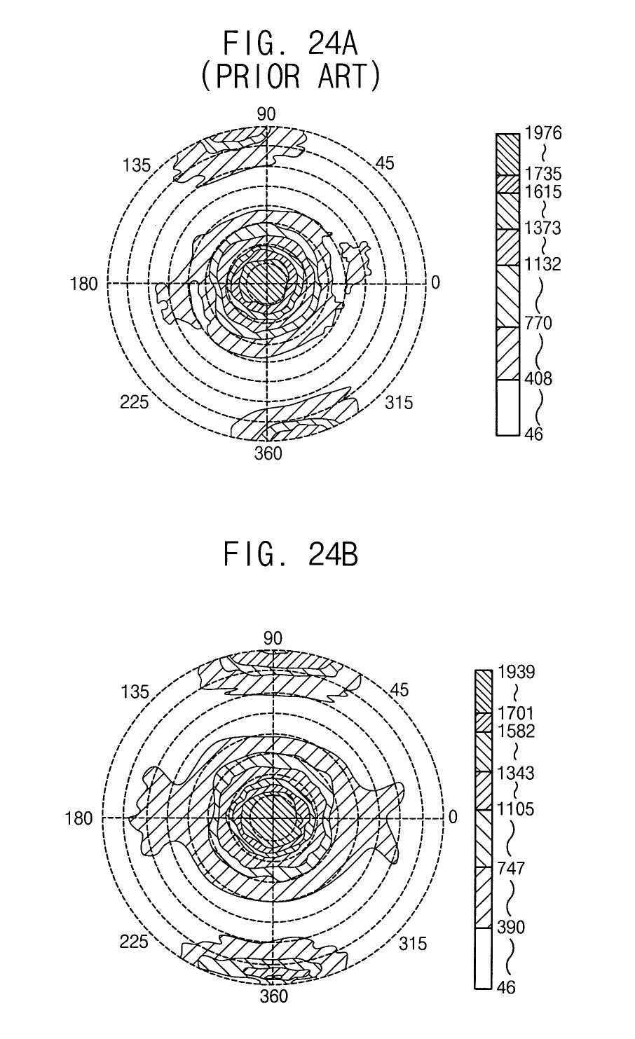

FIG. 24A is a graph illustrating luminance distribution measured from a conventional inverse prism film, and FIG. 24B is a graph illustrating luminance distribution measured from the first and second inverse prism film 10 and 12 of the present invention.

Referring to FIGS. 24A and 24B, FIG. 24B corresponds to the experimental example, and FIG. 24A corresponds to the comparative example. A center portion of FIGS. 24A and 24B corresponds to a high luminance portion and an edge portion of FIGS. 24A and 24B corresponds to a low luminance portion. A half region means a region having a having a luminance that is half of maximum luminance corresponding to a center of FIGS. 24A and 24B. The half region is defined as follows in Table 1.

TABLE 1

| Half region | Vertical angle | | Horizontal angle | |
|---|---|---|---|---|
| Experimental example | +22.2° | −22.5° | +25.0° | −25.3° |
| Comparative example | +20.1° | −2.04° | +23.4° | −22.9° |

Referring to Table 1, the half region according to an exemplary embodiment of the present invention increases about 20 both along positive and negative directions in both vertical and horizontal angles over the comparative example. This means that a region having half luminance of maximum luminance is widened to enhance luminance and luminance uniformity. Furthermore, a viewing angle also increased.

According to the present invention, an inverse prism film includes prism patterns discretely formed along x and y directions that are substantially perpendicular to each other. A height of each of first prism patterns decreases from a center of each of the first prism patterns toward edge portions of each of the first prism patterns. When viewed from a top of each of the first prism patterns, a width of each of the first prism patterns decreases from the center of each of the first prism patterns toward the edge portions of each of the first prism patterns. Therefore, luminance, luminance uniformity and viewing angle are enhanced.

As described above, the inverse prism film according to the present invention includes a first face having a plurality of prisms having shapes are described above and through which a light enters the inverse prism film and a second face through which the light exits the inverse prism film. Therefore, the light that enters the inverse prism film is condensed and diffused to enhance luminance.

Furthermore, the inverse prism film according to the present invention reduces a number of prism films in a liquid crystal display device to reduce weight and manufacturing cost of the liquid crystal display device.

Having described the exemplary embodiments of the present invention and its advantages, it is noted that various changes, substitutions and alterations can be made herein without departing from the spirit and scope of the invention as defined by appended claims.

1. An optical film comprising:
a base film; and
optical property enhancing members disposed at the base film, each of the optical property enhancing members having a boat bottom shape.

2. The optical film of claim 1, wherein each of the optical property enhancing members comprises a substantially triangular prism shaped protrusion disposed at a portion of the base film, the protrusion having a first end and a second end, the protrusion having a width substantially larger at a center portion of the protrusion than the width at both of the first and second ends, and the width of the protrusion gradually increase while proceeding from the first and second ends toward the center portion.

3. The optical film of claim 1, wherein each of the optical property enhancing members comprises a substantially triangular prism shaped protrusion disposed at a portion of the base film, the protrusion having a first end and a second end, the protrusion having a height substantially larger at a center portion of the protrusion than the height at both of the first and second ends, and the height of the protrusion gradually increase while proceeding from the first and second ends toward the center portion.

4. The optical film of claim 1, wherein the optical property enhancing members are spaced apart from each other.

5. The optical film of claim 1, wherein adjacent optical property enhancing members make contact with each other.

6. The optical film of claim 1, wherein the optical property enhancing members condense and diffuse an external light.

7. The optical film of claim 1, wherein a cross section of the optical property enhancing members, which is taken along a line that is substantially perpendicular to a longitudinal direction of each of the optical property enhancing members, has a saw tooth shape.

8. The optical film of claim 7, wherein a height of adjacent optical property enhancing members varies.

9. The optical film of claim 7, wherein each of the optical property enhancing members has a vertical angle in a range from about 60 degrees to about 90 degrees.

10. The optical film of claim 9, wherein the optical property enhancing members have the vertical angle of about 68 degrees.

11. The optical film of claim 1, wherein the base film has a uniform thickness and a height of adjacent optical property enhancing members varies.

12. The optical film of claim 1, wherein a cross section taken along a longitudinal length of each of the optical property enhancing members includes a rounded shape that has a constant curvature.

13. The optical film of claim 12, wherein each of the optical property enhancing members has a different curvature from adjacent optical property enhancing members.

14. The optical film of claim 1, wherein a cross section taken along a longitudinal length of each of the optical property enhancing members includes a first portion having a first curvature and a second portion having a second curvature, the first and second curvatures being different from each other.

15. The optical film of claim 1, wherein each of the optical property enhancing members includes two inclined surfaces facing each other, and the inclined surfaces are curved.

16. The optical film of claim 15, wherein a cross section of the optical property enhancing members, which is taken along a line that is substantially perpendicular to a longitudinal direction of each of the optical property enhancing members, has an entasis saw tooth shape having outwardly rounded edges.

17. The optical film of claim 1, wherein each of the optical property enhancing members includes first and second inclined surfaces facing each other, the first inclined surface is flat, and the second inclined surface is curved.

18. An optical film comprising:
a base film having a uniform thickness, the base film being disposed in an X-Y plane; and
optical property enhancing members protruding from the base film toward a Z-direction substantially perpendicular to the X-Y plane, a cross section of the optical property enhancing members taken along an X-Z plane having an arched shape to condense an external light, a cross section of the optical property enhancing members taken along a Y-Z plane having a saw tooth shape to condense the external light.

19. An optical film comprising:
a base film having a uniform thickness, the base film being disposed in an X-Y plane; and
optical property enhancing members protruding from the base film toward a Z-direction substantially perpendicular to the X-Y plane, a cross section of the optical property enhancing members taken along an X-Z plane having an arched shape to condense an external light, a cross section of the optical property enhancing members taken along a Y-Z plane having an entasis saw tooth shape to condense the external light.

20. A backlight assembly comprising:
a lamp that generates light; and
an optical film comprising a base film and optical property enhancing members having a boat bottom shape and being disposed at the base film.

21. The backlight assembly of claim 20, wherein the optical property enhancing members are disposed such that light generated by the lamp passes through the optical property enhancing members and the base film in sequence.

22. The backlight assembly of claim 20, further comprising a light guide plate that guides light generated by the lamp.

23. The backlight assembly of claim 22, wherein the optical film is disposed at the light guide plate such that the optical property enhancing members face the light guide plate.

24. The backlight assembly of claim 20, wherein a longitudinal direction of the optical property enhancing members is substantially parallel to a longitudinal direction of the lamp.

25. The backlight assembly of claim 20, wherein each of the optical property enhancing members comprises a substantially triangular prism shaped protrusion disposed at a portion of the base film, the protrusion having a first end and a second end, the protrusion having a width and a height substantially larger at a center portion of the protrusion than the width and the height at both of the first and second ends, and the width and the height of the protrusion gradually increase while proceeding from the first and second ends toward the center portion.

26. The backlight assembly of claim 25, wherein a cross section of the optical property enhancing members, which is taken along a line that is substantially perpendicular to a longitudinal direction of each of the optical property enhancing members, has a saw tooth shape.

27. The backlight assembly of claim 25, wherein a cross section of the optical property enhancing members, which is taken along a line that is substantially perpendicular to a longitudinal direction of each of the optical property enhancing members, has an entasis saw tooth shape.

28. The backlight assembly of claim 25, wherein a cross section of the optical property enhancing members, which is taken along a line that is substantially perpendicular to a longitudinal direction of each of the optical property enhancing members, has a first edge that is flat and a second edge that is curved.

29. The backlight assembly of claim 22, wherein the light guide plate includes prisms extended in a direction that is substantially perpendicular to a longitudinal direction of the optical property enhancing members, and a vertical angle of the prisms is in a range from about 100 degrees to about 120 degrees.

30. The backlight assembly of claim 29, wherein the optical property enhancing members have a vertical angle of about 60 degrees to about 90 degrees.

31. A liquid crystal display device comprising:
a light source that generates light;
a liquid crystal display panel that displays images using the light generated by the light source; and
a light adjusting member including a base film having first and second surfaces, and optical property enhancing members disposed at the first surface of the base film, the optical property enhancing members having a boat bottom shape, the light adjusting member receiving the light generated by the light source to enhance optical properties of the light and providing the light to the liquid crystal display panel.

32. The liquid crystal display device of claim 31, wherein the liquid crystal display panel is disposed at the second surface of the base film.

33. The liquid crystal display device of claim 31, wherein each of the optical property enhancing members comprises a substantially triangular prism shaped protrusion disposed at a portion of the base film, the protrusion having a first end and a second end, the protrusion having a width and a height substantially larger at a center portion of the protrusion than the width and the height at both of the first and second ends, and the width and the height of the protrusion gradually increase while proceeding from the first and second ends toward the center portion.

34. The liquid crystal display device of claim 33, wherein a cross section of the optical property enhancing members, which is taken along a line that is substantially perpendicular to a longitudinal direction of each of the optical property enhancing members, has a saw tooth shape.

35. The liquid crystal display device of claim 33, wherein a cross section of the optical property enhancing members, which is taken along a line that is substantially perpendicular to a longitudinal direction of each of the optical property enhancing members, has an entasis saw tooth shape.

36. The liquid crystal display device of claim 33, wherein a cross section of the optical property enhancing members, which is taken along a line that is substantially perpendicular to a longitudinal direction of each of the optical property enhancing members, has a first edge that is flat and a second edge that is curved.

37. The liquid crystal display device of claim 31, wherein the light adjusting member further comprises a light guide plate that guides the light generated from the light source, and the light guide plate is disposed proximate to the light adjusting member.

38. The liquid crystal display device of claim 31, wherein the light source comprises lamps disposed proximate to the liquid crystal display panel and parallel to each other.

39. A liquid crystal display device comprising:
a liquid crystal display panel that displays images using light; and
a backlight assembly that provides the liquid crystal display panel with the light, the backlight assembly including a prism film having prism patterns discretely formed thereon, the prism patterns being protruded toward the liquid crystal display panel, each of the prism patterns having an arch-shaped cross-sectional shape.

40. The liquid crystal display device of claim 39, wherein adjacent prism patterns have a different height from each other.

41. The liquid crystal display device of claim 39, wherein a height of each of the prism patterns decreases from a center portion toward an end portion of each of the prism patterns.

42. The liquid crystal display device of claim 41, wherein a width of each of the prism patterns decreases from the center portion toward the end portion of each of the prism patterns, when viewed from a top of each of the prism patterns.

43. The liquid crystal display device of claim 40, wherein a height ratio of the adjacent prism patterns is in a range from about 2.5:1 to about 4.0:1.

44. The liquid crystal display device of claim 40, wherein a height difference between the adjacent prism patterns is in a range from about 10 μm to about 25 μm.

45. The liquid crystal display device of claim 40, wherein an amount of about 85% to about 95% of light exits the prism film through a taller prism pattern, and an amount of about 5% to about 15% of light exits the prism film through a shorter prism pattern.

46. The liquid crystal display device of claim 39, wherein each of the prism patterns has a vertical angle of about 90 degrees, and the vertical angle is defined by two lines, each of the two lines being tangential to a surface of opposite sides of each of the prism patterns.

47. An optical film comprising:
a base film; and
prism patterns formed on the base film, each of the prism patterns having an arch-shaped cross-sectional shape.

48. The optical film of claim 47, wherein adjacent prism patterns have a different height from each other.

49. The optical film of claim 47, wherein a height of each of the prism patterns decreases from a center portion toward an end portion of the prism patterns.

50. The optical film of claim 49, wherein a width of each of the prism patterns decreases from the center portion toward the end portion, when viewed from a top of each of the prism patterns.

51. The optical film of claim 48, wherein a height ratio of the adjacent prism patterns is in a range from about 2.5:1 to about 4.0:1.

52. The optical film of claim 48, wherein a height difference between the adjacent prism patterns is in a range from about 10 μm to about 25 μm.

53. The optical film of claim 48, wherein about 85% to about 95% of light exits the prism film through a taller prism pattern, and an amount of about 5% to about 15% of light exits the prism film through a shorter prism pattern.

54. The optical film of claim 47, wherein each of the prism patterns has a vertical angle of about 90 degrees, and the vertical angle is defined by two lines, each of the two lines being tangential to a surface of opposite sides of each of the prism patterns.
